(19) United States
(12) Patent Application Publication
(10) Pub. No.: US 2019/0264649 A1
(43) Pub. Date: Aug. 29, 2019

(54) POWER GENERATING SYSTEM

(71) Applicant: Marion Patrick Chestnut, Conway (CA)

(72) Inventor: Marion Patrick Chestnut, Conway (CA)

(21) Appl. No.: 15/903,160

(22) Filed: Feb. 23, 2018

(51) Int. Cl. F03B 15/04; F03B 17/06; F03B 13/10; F03B 13/08; F03B 13/06

(52) U.S. Cl. CPC F03B 15/04; F03B 17/061; B65D 88/30; F03B 13/083; F03B 13/06; F03B 13/10

(57) ABSTRACT

A power generating system for generating hydroelectric power from a water treatment plant includes a recycled water source. A holding tank is in fluid communication with the recycled water source to receive recycled water from the recycled water source. A hydroelectric generator is fluidly coupled to the holding tank. The hydroelectric generator receives recycled water from the holding tank for generating electricity.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to generating devices and more particularly pertains to a new generating device for generating hydroelectric power from a water treatment plant.

### BRIEF SUMMARY OF THE INVENTION

An embodiment of the disclosure meets the needs presented above by generally comprising a recycled water source. A holding tank is in fluid communication with the recycled water source to receive recycled water from the recycled water source. A hydroelectric generator is fluidly coupled to the holding tank. The hydroelectric generator receives recycled water from the holding tank for generating electricity.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a power generating system according to an embodiment of the disclosure.

FIG. 2 is a schematic view of an embodiment of the disclosure.

### DETAILED DESCRIPTION OF THE INVENTION

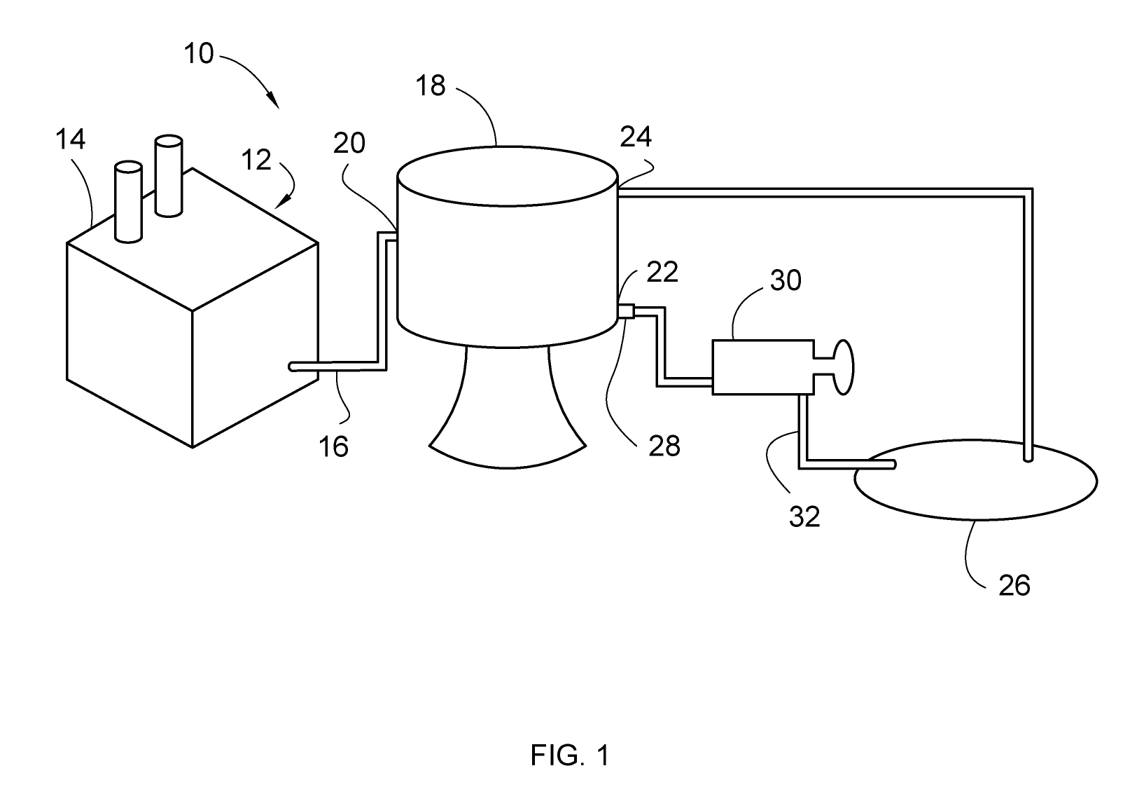

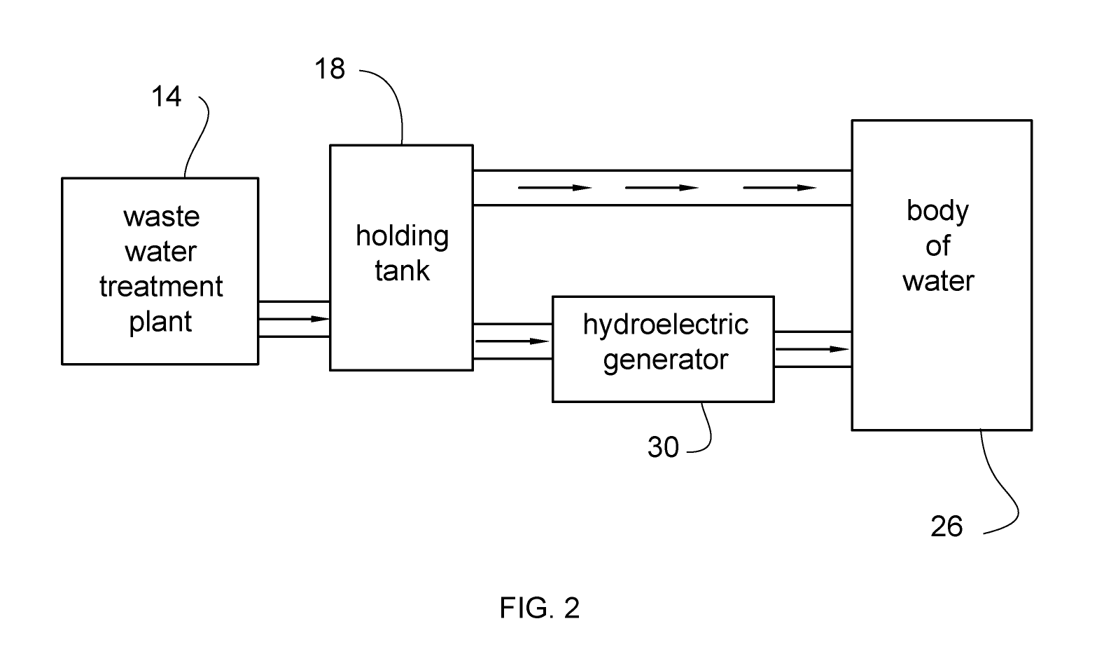

With reference now to the drawings, and in particular to FIGS. 1 through 2 thereof, a new generating device embodying the principles and concepts of an embodiment of the disclosure and generally designated by the reference numeral 10 will be described.

As best illustrated in FIGS. 1 through 2, the power generating system 10 generally comprises a recycled water source 12 comprising a waste water plant 14 that has an effluent outlet 16. The waste water plant 14 may be a municipal water treatment plant or the like. A holding tank 18 is provided and the holding tank 18 is in fluid communication with the recycled water source 12. The holding tank 18 has an input port 20, an outlet port 22 and an overflow port 24. The input port 20 is fluidly coupled to the effluent outlet 16 to receive wastewater from the effluent outlet 16. Additionally, the overflow port 24 is in fluid communication with a body of water 26, such as a pond, a lake and any other water repository.

An outlet valve 28 may be provided and the outlet valve 28 may be fluidly coupled to the outlet port 22. The outlet valve 28 may selectively open and close the outlet port 22 and the outlet valve 28 may be an electrically controlled fluid valve or the like. Additionally, the outlet valve 28 may be remotely controlled via a control system in the waste water plant 14. In this way wastewater may be selectively released from the outlet port 22.

A hydroelectric generator 30 is provided and the hydroelectric generator 30 is fluidly coupled to the outlet port 22 on the holding tank 18. The holding tank 18 is elevated above the hydroelectric generator 30 to gravity feed the wastewater to the hydroelectric generator 30. Thus, the hydroelectric generator 30 receives the wastewater from the holding tank 18 for generating electricity. The hydroelectric generator 30 has an exhaust 32 that releases the wastewater from the hydroelectric generator 30 and the exhaust 32 is in fluid communication with the body of water 26. The hydroelectric generator 30 is electrically coupled to an electrical distribution system such as a power grid for a municipality or the like.

In use, the holding tank 18 and the hydroelectric generator 30 are retrofitted onto existing water treatment plants. Additionally, the holding tank 18 and the hydroelectric generator 30 may be integral components of newly built water treatment plants. The outlet valve 28 is selectively actuated to release the wastewater into the hydroelectric generator 30. In this way the hydroelectric generator 30 converts the kinetic energy of flowing wastewater into electrical energy. The hydroelectric generator 30 transfers the electrical energy into the electrical distribution system for consumption.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A power generating system using wastewater effluent to drive a hydroelectric turbine, said system comprising:
a recycled water source;
a holding tank being in fluid communication with said recycled water source wherein said holding tank is configured to receive recycled water from said recycled water source, said holding tank having an output port, said holding tank having an overflow port discrete from said output port, said overflow port being in fluid communication with a body of water; and
a hydroelectric generator being fluidly coupled to said output port of said holding tank wherein said hydroelectric generator is configured to receive recycled water from said holding tank for generating electricity, said holding tank being.

2. The system according to claim 1, wherein said recycled water source comprises a waste water plant having an effluent outlet.

3. The system according to claim 2, wherein said holding tank has an input port being fluidly coupled to said effluent outlet wherein said input port is configured to receive wastewater from said effluent outlet.

4. The system according to claim 1, wherein
said hydroelectric generator is electrically coupled to an electrical distribution system.

5. (canceled)

6. The system according to claim 1, wherein said hydroelectric generator has an exhaust being configured to release the recycled water from said hydroelectric generator, said exhaust being in fluid communication with the body of water.

7. A power generating system using wastewater effluent to drive a hydroelectric turbine, said system comprising:
a recycled water source comprising a waste water plant having an effluent outlet;
a holding tank being in fluid communication with said recycled water source, said holding tank having an input port, an outlet port and an overflow port, said overflow port being discrete from said outlet port, said inlet port being fluidly coupled to said effluent outlet wherein said input port is configured to receive wastewater from said effluent outlet, said overflow port being in fluid communication with a body of water; and
a hydroelectric generator being fluidly coupled to said holding tank wherein said hydroelectric generator is configured to receive recycled water from said holding tank for generating electricity, said hydroelectric generator being in fluid communication with said outlet port on said holding tank, said hydroelectric generator having an exhaust being configured to release the recycled water from said hydroelectric generator, said exhaust being in fluid communication with the body of water, said hydroelectric generator being electrically coupled to an electrical distribution system.
